(19) United States
(12) Patent Application Publication
(10) Pub. No.: US 2022/0392249 A1
(43) Pub. Date: Dec. 8, 2022

(54) DEEP FINGER ULTRASONIC SENSOR

(71) Applicant: TDK CORPORATION, Tokyo (JP)

(72) Inventors: Leonardo BALDASARRE, Varese (IT); Marco TRAVAGLIATI, Pavia (IT); Dima CHUNG, Seoul (KR)

(73) Assignee: TDK CORPORATION, Tokyo (JP)

(21) Appl. No.: 17/833,661

(22) Filed: Jun. 6, 2022

Related U.S. Application Data
(60) Provisional application No. 63/197,977, filed on Jun. 7, 2021.

(51) Int. Cl. G06V 40/13; G01S 15/89; G10K 11/34; G01S 7/52

(52) U.S. Cl. CPC G06V 40/1306; G01S 15/8993; G01S 15/8915; G10K 11/346; G01S 7/5208

(57) ABSTRACT

A deep finger ultrasonic sensor device includes an array of ultrasonic transducers and an array controller configured to control activation of ultrasonic transducers of the array of ultrasonic transducers during an imaging operation for capturing a depth image of a finger, where the depth image includes a plurality of features inside the finger. The array controller is configured to control transmission of ultrasonic signals and receipt of reflected ultrasonic signals during the imaging operation, where the reflected ultrasonic signals are utilized in generating the depth image of the finger.

### RELATED APPLICATION

This application claims priority to and the benefit of co-pending U.S. Provisional Patent Application 63/197,977, filed on Jun. 7, 2021, entitled “DEEP FINGER ULTRASONIC SENSOR,” by Baldasarre, et al., having Attorney Docket No. IVS-1006-PR, and assigned to the assignee of the present application, which is incorporated herein by reference in its entirety.

### BACKGROUND

Fingerprint sensors have become ubiquitous in mobile devices as well as other devices (e.g., locks on cars and buildings) and applications for authenticating a user's identity. They provide a fast and convenient way for the user to unlock a device, provide authentication for payments, etc. However, given the narrow form factor of some mobile devices, and the desired placement of a sensor on a narrow side of such mobile devices, fingerprint sensors may be too narrow and elongated to capture a fingerprint image sufficient for matching to an enrolled fingerprint image.

### BRIEF DESCRIPTION OF THE DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 is a block diagram of an example electronic device upon which embodiments described herein may be implemented.

FIGS. 2A and 2B illustrates an example deep finger ultrasonic sensor device, according to embodiments.

FIG. 3A illustrates beamforming of an example ultrasonic sensor with phase delayed transmission, according to embodiments.

FIG. 3B illustrates an example field of view of a deep finger ultrasonic sensor device, according to embodiments.

FIGS. 4A and 4B represent simplified and idealized different interior views of a finger and a plurality of features therein, according to embodiments.

FIG. 5 illustrates an example depth image of a finger, according to an embodiment.

FIG. 6A illustrates an example mobile electronic device having a side-mounted deep finger ultrasonic sensor device, according to an embodiment.

FIG. 6B illustrates an example mobile electronic device having a side-mounted deep finger ultrasonic sensor device and fingerprint sensor, according to an embodiment.

FIGS. 7A through 7D illustrate example hardware configurations of a fingerprint sensing system, according to various embodiments.

FIG. 8 illustrates an example configuration of the operation of the fingerprint imaging sensor and a depth image sensor in conjunction with an authentication module, according to an embodiment.

FIG. 9 illustrates an example data flow diagram for user authentication using a deep finger ultrasonic sensor, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “capturing,” “performing,” “determining,” “detecting,” “interacting,” “imaging,” “operating,” “sensing,” “controlling,” “activating,” “beamform ing,” “transmitting,” “receiving,” “generating,” “matching,” “using,” “comparing,” “executing,” “storing,” or the like, refer to the actions and processes of an electronic device such as an electrical device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing and deep finger ultrasonic sensor device and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example electronic device including a fingerprint sensor, upon which described embodiments can be implemented. An example deep finger ultrasonic sensor device is then described, in accordance with various embodiments. Example operations for operating a system for fingerprint authentication using a deep finger ultrasonic sensor device are then described.

Authentication systems are widely used in electronic devices, such as mobile electronic devices and applications operating on mobile electronic devices and electronic locks for accessing cars or buildings, for protecting against unauthorized access to the devices and/or applications. Authentication is performed before providing user access to a device and/or application by first ensuring that the user is permitted to have such access. For example, fingerprint sensors can be used by comparing a fingerprint image captured during an authentication operation to a previously stored enrollment image. Typical fingerprint sensors may be based on different principles such as capacitive, optical, or ultrasound technologies. However, given the narrow form factor of some mobile devices, and the desired placement of a sensor on a narrow side of such mobile devices, fingerprint sensors may be too narrow and elongated to capture a fingerprint image sufficient for matching to an enrolled fingerprint image. Furthermore, depending on the type of electronic device or application, heightened security measures based on fingerprint images alone may not be sufficient.

Embodiments described herein provide a deep finger ultrasonic sensor device, also referred to herein as a “deep finger sensor” or a “depth image sensor,” for performing deep finger sensing for capturing a depth image of a finger, where the depth image includes a plurality of features inside the finger. The described deep finger includes an array of ultrasonic transducers and an array controller configured to control activation of ultrasonic transducers of the array of ultrasonic transducers during an imaging operation for capturing the depth image of a finger. In some embodiments, the array of ultrasonic transducers is a one-dimensional array of ultrasonic transducers. The array controller is configured to control transmission of ultrasonic signals and receipt of reflected ultrasonic signals during the imaging operation, where the reflected ultrasonic signals are utilized in generating the depth image of the finger.

In accordance with various embodiments, the features inside the finger can include, without limitation: a dermis epidermis interface, a capillary, a blood vessel, a tendon, an artery, a nerve, a bone, a fascial septa, and a Meissner's corpuscle. In some embodiments, the depth image includes a cross-section image of the finger including the plurality of features inside the finger. In some embodiments, the array controller is further configured to control beamforming during the imaging operation, wherein the beamforming controls a field of view of the array of ultrasonic transducers.

In some embodiments, the deep finger ultrasonic sensor device further includes a sensor processor configured to generate the depth image of the finger based at least in part on the reflected ultrasonic signals. In some embodiments, the sensor processor is further configured to store a first depth image of the finger as an enrollment depth image. In some embodiments, the deep finger ultrasonic sensor device is further configured to perform finger authentication by comparing a second depth image to the first depth image. In some embodiments, the deep finger ultrasonic sensor device is mounted on a side of a mobile electronic device.

Other embodiments described herein provide a method for deep finger sensing using an array of ultrasonic transducers. Ultrasonic signals are transmitted into a finger using the array of ultrasonic transducers. Reflected ultrasonic signals are received at the array of ultrasonic transducers. A depth image of the finger is generated based at least in part on the reflected ultrasonic signals, where the depth image comprises a cross-section image of the finger comprising a plurality of features inside the finger. In some embodiments, transmitting the ultrasonic signals into the finger using the array of ultrasonic transducers includes beamforming the ultrasonic signals, where the beamforming controls a field of view of the array of ultrasonic transducers. In some embodiments, a first depth image of the finger is stored as an enrollment depth image. In some embodiments, finger authentication is performed by comparing a second depth image to the first depth image.

Moreover, in order to circumvent fingerprint authentication, attempts can be made to copy or spoof fingerprints of an authorized user using a fake or artificial finger. As such, fingerprint sensors should be capable of distinguishing real fingers from fake, artificial, or even dead fingers, also referred to herein as performing “spoof detection,” “fake finger detection,” or “liveness detection.” A “spoofed” fingerprint is a fake or artificial fingerprint that is used to attempt to circumvent security measures requiring fingerprint authentication. For example, an artificial finger may be used to gain unauthorized access to the electronic device or application, by making an unauthorized copy of the fingerprint of an authorized user, e.g., “spoofing” an actual fingerprint.

Embodiments described herein provide a user authentication system including a fingerprint imaging sensor and a deep finger sensor. The fingerprint imaging sensor includes a two-dimensional array of ultrasonic transducers for capturing a fingerprint image of a finger. The deep finger sensor includes a one-dimensional array of ultrasonic transducers for capturing a depth image of the finger, where the depth image comprises a cross-section image of the finger comprising a plurality of features inside the finger. A processor of the user authentication system is configured to perform a user authentication operation using the fingerprint image and the depth image. In some embodiments, the processor is further configured to store a first fingerprint image as an enrollment fingerprint image and store a first depth image of the finger as an enrollment depth image. In some embodiments, the processor is further configured to perform finger authentication by comparing a second fingerprint image to the first fingerprint image and a second depth image to the first depth image.

By cooperatively performing user authentication using a combination of fingerprint image analysis and finger depth image analysis, the described embodiments provide enhanced security operations. For instance, in order to “spoof” user authentication using a combination of fingerprint image analysis and finger depth image analysis, a fake finger must include accurate representations of both a surface of a finger and internal features of the finger, significantly increasing the difficulty of fake finger creation by potential spoofers.

### Example Mobile Electronic Device

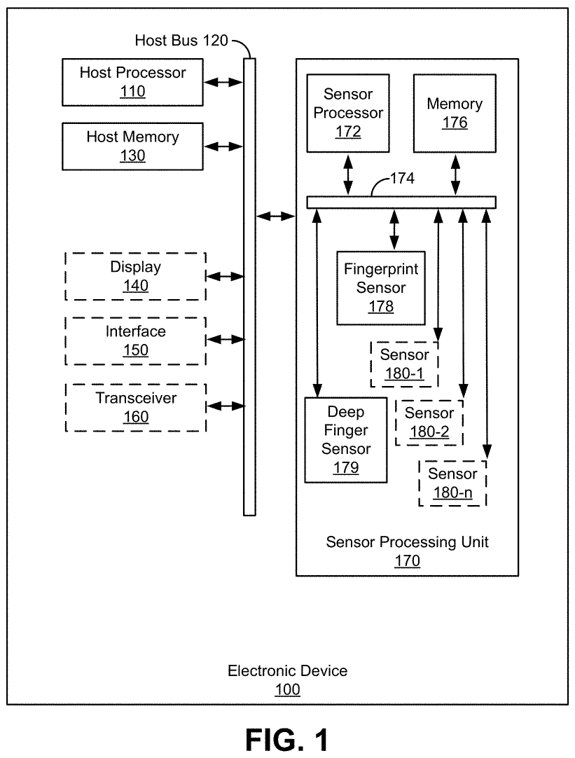

Turning now to the figures, FIG. 1 is a block diagram of an example electronic device 100. As will be appreciated, electronic device 100 may be implemented as a device or apparatus, such as a handheld mobile electronic device. For example, such a mobile electronic device may be, without limitation, a mobile telephone phone (e.g., smartphone, cellular phone, a cordless phone running on a local network, or any other cordless telephone handset), a wired telephone (e.g., a phone attached by a wire), a personal digital assistant (PDA), a video game player, video game controller, a Head Mounted Display (HMD), a virtual or augmented reality device, a navigation device, an activity or fitness tracker device (e.g., bracelet, clip, band, or pendant), a smart watch or other wearable device, a mobile internet device (MID), a personal navigation device (PND), a digital still camera, a digital video camera, a portable music player, a portable video player, a portable multi-media player, a remote control, health monitoring device, wellness monitoring device, medical device, or a combination of one or more of these devices. In other embodiments, electronic device 100 may be implemented as a fixed electronic device, such as and without limitation, an electronic lock, a doorknob, a car start button, an automated teller machine (ATM), etc. In accordance with various embodiments, electronic device 100 is capable of reading fingerprints and depth images of fingers.

As depicted in FIG. 1, electronic device 100 may include a host processor 110, a host bus 120, a host memory 130, and a sensor processing unit 170. Some embodiments of electronic device 100 may further include one or more of a display device 140, an interface 150, a transceiver 160 (all depicted in dashed lines) and/or other components. In various embodiments, electrical power for electronic device 100 is provided by a mobile power source such as a battery (not shown), when not being actively charged.

Host processor 110 can be one or more microprocessors, central processing units (CPUs), DSPs, general purpose microprocessors, ASICs, ASIPs, FPGAs or other processors which run software programs or applications, which may be stored in host memory 130, associated with the functions and capabilities of electronic device 100.

Host bus 120 may be any suitable bus or interface to include, without limitation, a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. In the embodiment shown, host processor 110, host memory 130, display 140, interface 150, transceiver 160, sensor processing unit (SPU) 170, and other components of electronic device 100 may be coupled communicatively through host bus 120 in order to exchange commands and data. Depending on the architecture, different bus configurations may be employed as desired. For example, additional buses may be used to couple the various components of electronic device 100, such as by using a dedicated bus between host processor 110 and memory 130.

Host memory 130 can be any suitable type of memory, including but not limited to electronic memory (e.g., read only memory (ROM), random access memory, or other electronic memory), hard disk, optical disk, or some combination thereof. Multiple layers of software can be stored in host memory 130 for use with/operation upon host processor 110. For example, an operating system layer can be provided for electronic device 100 to control and manage system resources in real time, enable functions of application software and other layers, and interface application programs with other software and functions of electronic device 100. Similarly, a user experience system layer may operate upon or be facilitated by the operating system. The user experience system may comprise one or more software application programs such as menu navigation software, games, device function control, gesture recognition, image processing or adjusting, voice recognition, navigation software, communications software (such as telephony or wireless local area network (WLAN) software), and/or any of a wide variety of other software and functional interfaces for interaction with the user can be provided. In some embodiments, multiple different applications can be provided on a single electronic device 100, and in some of those embodiments, multiple applications can run simultaneously as part of the user experience system. In some embodiments, the user experience system, operating system, and/or the host processor 110 may operate in a low-power mode (e.g., a sleep mode) where very few instructions are processed. Such a low-power mode may utilize only a small fraction of the processing power of a full-power mode (e.g., an awake mode) of the host processor 110.

Display 140, when included, may be a liquid crystal device, (organic) light emitting diode device, or other display device suitable for creating and visibly depicting graphic images and/or alphanumeric characters recognizable to a user. Display 140 may be configured to output images viewable by the user and may additionally or alternatively function as a viewfinder for camera. It should be appreciated that display 140 is optional, as various electronic devices, such as electronic locks, doorknobs, car start buttons, etc., may not require a display device.

Interface 150, when included, can be any of a variety of different devices providing input and/or output to a user, such as audio speakers, touch screen, real or virtual buttons, joystick, slider, knob, printer, scanner, computer network I/O device, other connected peripherals and the like.

Transceiver 160, when included, may be one or more of a wired or wireless transceiver which facilitates receipt of data at electronic device 100 from an external transmission source and transmission of data from electronic device 100 to an external recipient. By way of example, and not of limitation, in various embodiments, transceiver 160 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications for wireless personal area network communication), and a wired a serial transceiver (e.g., a universal serial bus for wired communication).

Electronic device 100 also includes a sensor assembly in the form of integrated Sensor Processing Unit (SPU) 170 which includes sensor processor 172, memory 176, a fingerprint sensor 178, deep finger sensor 179, and a bus 174 for facilitating communication between these and other components of SPU 170. In some embodiments, SPU 170 may include at least one additional sensor 180 (shown as sensor 180-1, 180-2, . . . 180-n) communicatively coupled to bus 174. In some embodiments, at least one additional sensor 180 is a force or pressure sensor (e.g. a touch sensor) configured to determine a force or pressure or a temperature sensor configured to determine a temperature at electronic device 100. The force or pressure sensor may be disposed within, under, or adjacent fingerprint sensor 178 and/or deep finger sensor 179. In some embodiments, all of the components illustrated in SPU 170 may be embodied on a single integrated circuit. It should be appreciated that SPU 170 may be manufactured as a stand-alone unit (e.g., an integrated circuit), that may exist separately from a larger electronic device and is coupled to host bus 120 through an interface (not shown). It should be appreciated that, in accordance with some embodiments, that SPU 170 can operate independent of host processor 110 and host memory 130 using sensor processor 172 and memory 176.

Sensor processor 172 can be one or more microprocessors, CPUs, DSPs, general purpose microprocessors, ASICs, ASIPs, FPGAs or other processors which run software programs, which may be stored in memory 176, associated with the functions of SPU 170. It should also be appreciated that fingerprint sensor 178, deep finger sensor 179, and additional sensor 180, when included, may also utilize processing and memory provided by other components of electronic device 100, e.g., host processor 110 and host memory 130.

Bus 174 may be any suitable bus or interface to include, without limitation, a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. In the embodiment shown, sensor processor 172, memory 176, fingerprint sensor 178, and other components of SPU 170 may be communicatively coupled through bus 174 in order to exchange data.

Memory 176 can be any suitable type of memory, including but not limited to electronic memory (e.g., read only memory (ROM), random access memory, or other electronic memory). Memory 176 may store algorithms or routines or other instructions for processing data received from fingerprint sensor 178 and/or one or more sensor 180, as well as the received data either in its raw form or after some processing. Such algorithms and routines may be implemented by sensor processor 172 and/or by logic or processing capabilities included in fingerprint sensor 178, deep finger sensor 179, and/or sensor 180.

A sensor 180 may comprise, without limitation: a temperature sensor, touch sensor, a humidity sensor, an atmospheric pressure sensor, an infrared sensor, a radio frequency sensor, a navigation satellite system sensor (such as a global positioning system receiver), an acoustic sensor (e.g., a microphone), an inertial or motion sensor (e.g., a gyroscope, accelerometer, or magnetometer) for measuring the orientation or motion of the sensor in space, or other type of sensor for measuring other physical or environmental factors. In one example, sensor 180-1 may comprise an acoustic sensor, sensor 180-2 may comprise a temperature sensor, and sensor 180-n may comprise a motion sensor.

In some embodiments, fingerprint sensor 178, deep finger sensor 179, and/or one or more sensors 180 may be implemented using a microelectromechanical system (MEMS) that is integrated with sensor processor 172 and one or more other components of SPU 170 in a single chip or package. It should be appreciated that fingerprint sensor 178 and or deep finger sensor 179 may be disposed behind display 140. Although depicted as being included within SPU 170, one, some, or all of fingerprint sensor 178, deep finger sensor 179, and/or one or more sensors 180 may be disposed externally to SPU 170 in various embodiments. It should be appreciated that fingerprint sensor 178 can be any type of fingerprint sensor, including without limitation, an ultrasonic sensor, an optical sensor, a camera, etc.

### Example Deep Finger Ultrasonic Sensor Device

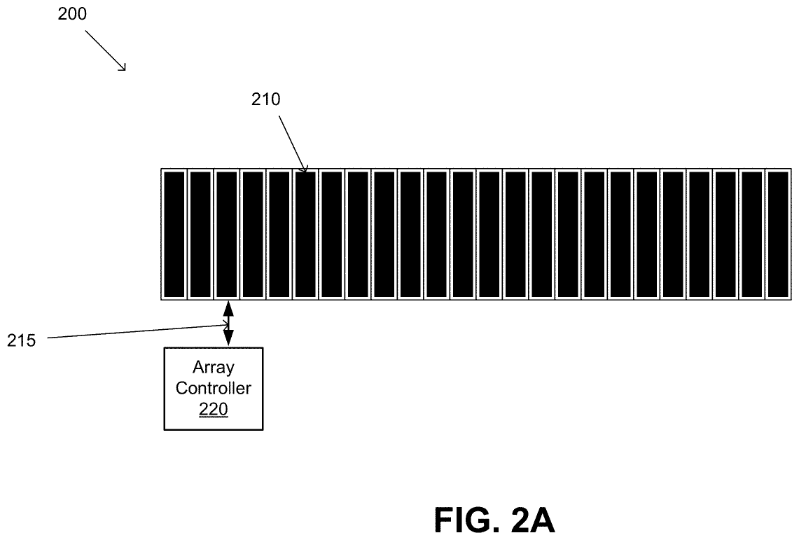

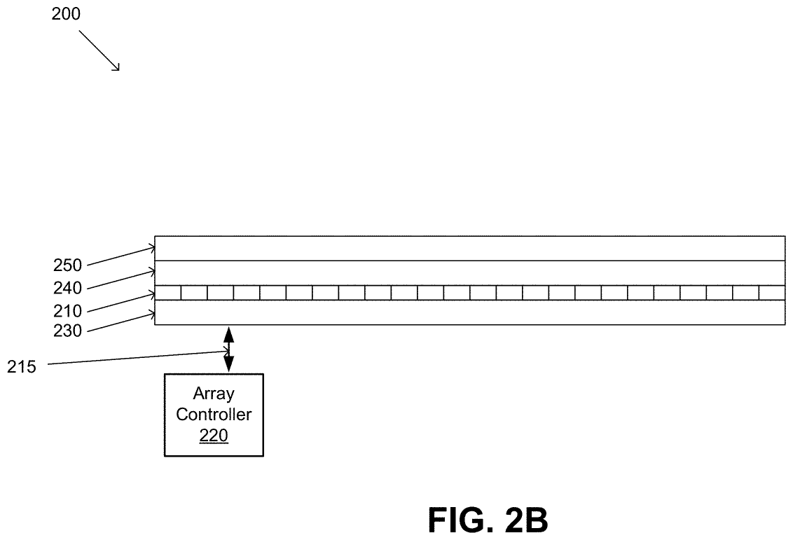

FIGS. 2A and 2B illustrate different views of deep finger ultrasonic sensor device 200, according to an embodiment. As illustrated in the plan view of FIG. 2A, deep finger ultrasonic sensor device 200 includes an array of ultrasonic transducers 210, e.g., piezoelectric micromachined ultrasonic transducers (PMUTs) or bulk piezo actuator elements, that may be used emit and detect ultrasonic waves. In the illustrated embodiment, deep finger ultrasonic sensor device 200 includes a one-dimensional array of ultrasonic transducers 210. However, it should be appreciated that deep finger ultrasonic sensor device 200 can include a two-dimensional array of ultrasonic transducers 210, and is not limited to the illustrated embodiment. Moreover, it should be appreciated that deep finger ultrasonic sensor device 200 can include any number of ultrasonic transducers 210, and is not limited to the illustrated embodiment. For example, deep finger ultrasonic sensor device 200 can include a one-dimensional array of twenty-four ultrasonic transducers 210 (as illustrated), a one-dimensional array of ninety-six ultrasonic transducers 210, or any other number of ultrasonic transducers 210 arranged in a one-dimensional or two-dimensional array.

As illustrated, ultrasonic transducers 210 are rectangular in shape (e.g., 1000 μm by 42 μm). However, it should be appreciated that ultrasonic transducers 210 of deep finger ultrasonic sensor device 200 can be of any shape or size, e.g., circular, square, rectangular, hexagonal, etc., and is not limited to the illustrated embodiment.

With reference to the side view of FIG. 2B, deep finger ultrasonic sensor device 200 includes the array of ultrasonic transducers 210 on a substrate 230 (e.g., a CMOS substrate). In the illustrated embodiment, deep finger ultrasonic sensor device 200 also includes acoustic coupling layer 240 above the array of ultrasonic transducers 210 for supporting transmission of acoustic signals. It should be appreciated that acoustic coupling layer can include air, liquid, plastic, epoxy, or gels such as polydimethylsiloxane (PDMS), or other materials for supporting transmission of acoustic signals. In one embodiment, deep finger ultrasonic sensor device 200 also includes contact layer 250 above acoustic coupling layer 240 for covering acoustic coupling layer 240 and providing a contact surface for a finger or other sensed object with deep finger ultrasonic sensor device 200. It should be appreciated that, in various embodiments, acoustic coupling layer 240 provides a contact surface, such that contact layer 250 is optional. It should be appreciated that deep finger ultrasonic sensor device 200 can include additional layers (not illustrated), such as a mechanical support layer (e.g., a stiffening layer) to mechanically stiffen the layers. In various embodiments, such a mechanical support layer may include at least one of, and without limitation, silicon, silicon oxide, silicon nitride, aluminum, molybdenum, titanium, etc.

Deep finger ultrasonic sensor device 200 may use various techniques to sense or detect features within a finger, e.g., acoustic or ultrasonic techniques. Array controller 220 is configured to control activation of ultrasonic transducers 210 during an imaging operation for capturing a depth image of an object (e.g., a finger), where the depth image includes a plurality of features inside the object. It should be appreciated that the functionality of array controller 220 may be performed by a dedicated array controller, a sensor processor (e.g., sensor 172 of FIG. 1), a host processor (e.g., host processor 110 of FIG. 1), or any combination thereof. Array controller 220 is communicatively coupled to each ultrasonic transducer 210 via electrical connections 215, which is representative of the individual connections between array controller 220 and each ultrasonic transducer 210, such that each ultrasonic transducer 210 can be directly controller by array controller 220. For instance, substrate 230 includes the electrical connections 215 between array controller 220 and each ultrasonic transducer 210.

Array controller 220 is configured to control transmission of ultrasonic signals by ultrasonic transducers 210 and receipt of reflected ultrasonic signals during the imaging operation at ultrasonic transducers 210, where the reflected ultrasonic signals are utilized in generating the depth image of the object. During an imaging operation for capturing a depth image, under the control of array controller 220, ultrasonic signals are generated at ultrasonic transducers 210 and transmitted into an object (e.g., a finger) interacting with deep finger ultrasonic sensor device 200. Ultrasonic signals travel through any transmission medium and intervening layers (e.g., a contact layer or platen, not illustrated) and into the object, reflecting of internal features of the object, where at least a portion of ultrasonic signals are reflected back toward deep finger ultrasonic sensor device 200.

It should be appreciated that in accordance with various embodiments, ultrasonic signals are focused into the object interacting with deep finger ultrasonic sensor device 200. It should be appreciated that different beamforming techniques can be used to focus the beams to different depths into the object. For example, during the imaging operation, a plurality of ultrasonic transducers operate collectively to generate a beam, where transmission activation of at least some of the ultrasonic transducers for generating an acoustic signal are phase delayed with respect to other ultrasonic transducers. By controlling the phase delayed activation of ultrasonic transducers, the resulting beam can be formed and steered to a particular direction with a particular focal point.

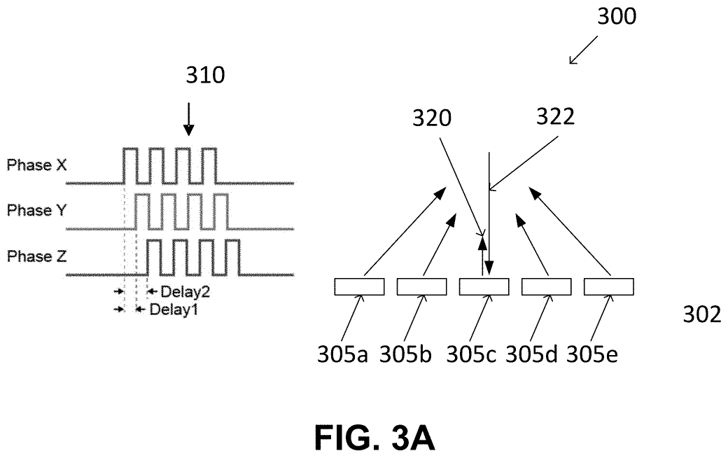

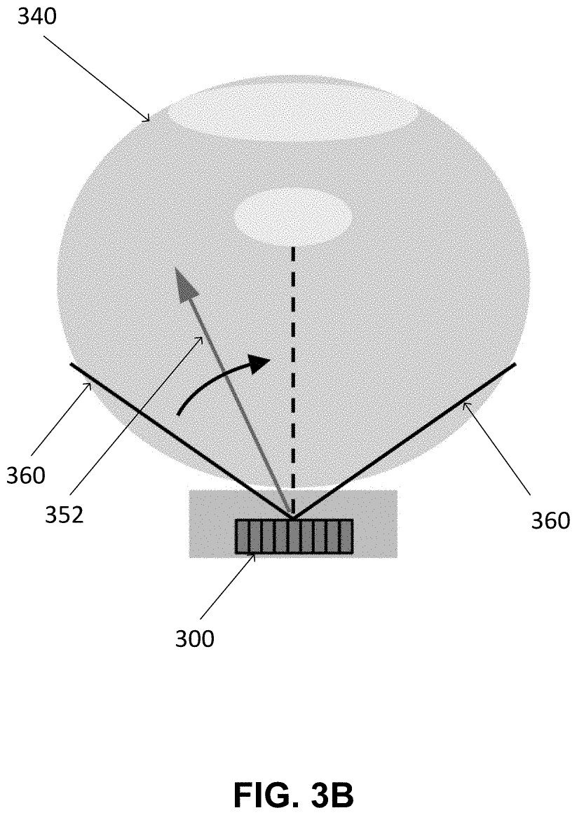

FIG. 3A illustrates beamforming of an example deep finger ultrasonic sensor device 300 with phase delayed transmission, according to embodiments, for illustrating how beamforming and beam steering can be applied to deep finger ultrasonic sensor device 200 of FIGS. 2A and 2B. As illustrated, FIG. 3A shows ultrasonic beam transmission and reception using five ultrasonic transducers of a one-dimensional array of ultrasonic transducers (e.g., ultrasonic transducers 210 of deep finger ultrasonic sensor device 200 of FIGS. 2A and 2B) having phase delayed inputs 310. As illustrated, ultrasonic sensor 300 includes at least five ultrasonic transducers 305a-e including a piezoelectric material and activating electrodes for generating and sensing ultrasonic signals.

In operation, and as illustrated in FIG. 3A, ultrasonic transducers 305a and 305e are activated using phase X of phase delayed inputs 310 at an initial time. At a second time, (e.g., 1-100 nanoseconds later), ultrasonic transducers 305b and 305d are activated using phase Y of phase delayed inputs 310. At a third time (e.g., 1-100 nanoseconds after the second time) ultrasonic transducer 305c is activated using phase Z of phase delayed inputs 310. The ultrasonic waves interfere transmitted at different times cause interference with each other, effectively resulting in a single high intensity beam 320 that exits the ultrasonic sensor, contacts an object and is emitted into the object, such as a finger (not shown), that interacts with the ultrasonic sensor (e.g., in contact with contact layer 250 of FIG. 2B), and is in part reflected back to ultrasonic transducers 305a-e. In one embodiment, ultrasonic transducers 305a-e are switched from a transmission mode to a reception mode, allowing ultrasonic transducer 305c to detect any reflected signals 322. In other words, the phase delay pattern of the ultrasonic transducers 305a-e is symmetric about the focal point where high intensity beam 320 exits deep finger ultrasonic sensor device 300.

In other embodiments, the phase delay pattern of transmitting ultrasonic transducers 305a-e is asymmetric about a focal point of the focused ultrasonic beam of the transmitting ultrasonic transducers. For example, such a phase delay pattern allows for sensing of an object or within an object off-center of the transmitting ultrasonic transducers and could be used for array positions adjacent to or beyond the edge of the array of ultrasonic transducers. These embodiments may also be referred to as beam steering, as the phase delay pattern steers a focal point of the beam to a position off-center relative to the group of transmitting ultrasonic transducers.

It should be appreciated that an ultrasonic transducer 305a-e of the ultrasonic sensor 300 may be used to transmit and/or receive an ultrasonic signal, and that the illustrated embodiment is a non-limiting example. The received signal (e.g., generated based on reflections, echoes, etc. of the acoustic signal from an object contacting or near deep finger ultrasonic sensor device 300) can then be analyzed. As an example, a depth image of features within the object, a distance of features within the object from the sensing component, acoustic impedance of features within the object, a motion of features within the object, etc., can all be determined based on comparing a frequency, amplitude, phase and/or arrival time of the received signal with a frequency, amplitude, phase and/or transmission time of the transmitted acoustic signal. Moreover, results generated can be further analyzed or presented to a user via a display device (not shown).

FIG. 3B illustrates an example field of view 360 of a deep finger ultrasonic sensor device 300, according to embodiments. As illustrated, finger 340 is shown interacting with deep finger ultrasonic sensor device 300. Deep finger ultrasonic sensor device 300 generates multiple signals ultrasonic signal 352 over field of view 360 by using the beamforming and beam forming as described above in accordance with FIG. 3A. In some embodiments, deep finger ultrasonic sensor device 300 is capable of imaging a cross-section view into finger 340 of a field of view 360 that is wider than the surface of deep finger ultrasonic sensor device 300 itself. As such, a relatively small deep finger ultrasonic sensor device 300 can be used to generate a depth image into finger 340 far wider than the width of deep finger ultrasonic sensor device 300.

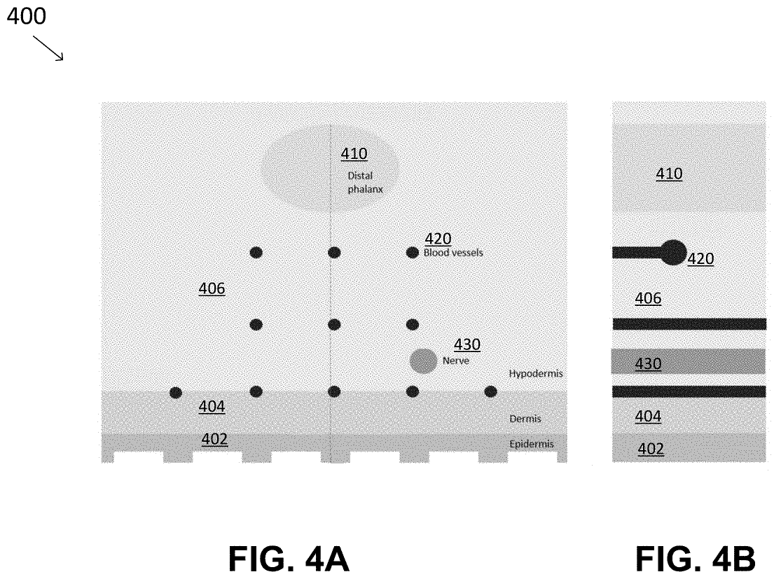

FIGS. 4A and 4B represent simplified and idealized different interior views with of the main target features of the finger, according to embodiments. It should be appreciated that FIGS. 4A and 4B are simplified examples of features found within a finger 400, for purposes of illustrating concepts enabled by the described embodiments, and that the interior of a finger would not exhibit the symmetry and well-defined placement of features found within a finger. While many features found within a finger are illustrated in FIGS. 4A and 4B, it should be appreciated that other features could also be found. For example, in accordance with various embodiments, the features inside the finger can include, without limitation: a dermis epidermis interface, a capillary, a blood vessel, a tendon, an artery, a nerve, a bone, a fascial septa, and a Meissner's corpuscle.

FIG. 4A illustrates a traverse cross-section with respect to the distal phalanx of a finger 400, and FIG. 4B illustrates a longitudinal cross-section with respect to the distal phalanx of the finger 400. Embodiments described herein are capable of capturing cross-sectional depth images of feature within a finger 400 including the plurality of features inside the finger. For example, as illustrated in FIG. 4A, the size and relative positions of features of within the finger can be captured as a depth image, and then used for facilitating user authentication.

Finger 400 includes epidermis 402, dermis 404, and hypodermis 406. Hypodermis 406 includes a number of features, including distal phalanx 410, blood vessels 420, and nerve 430. By generating a depth image of the features within finger 400, the depth image can be stored as an enrollment image for later user authentication.

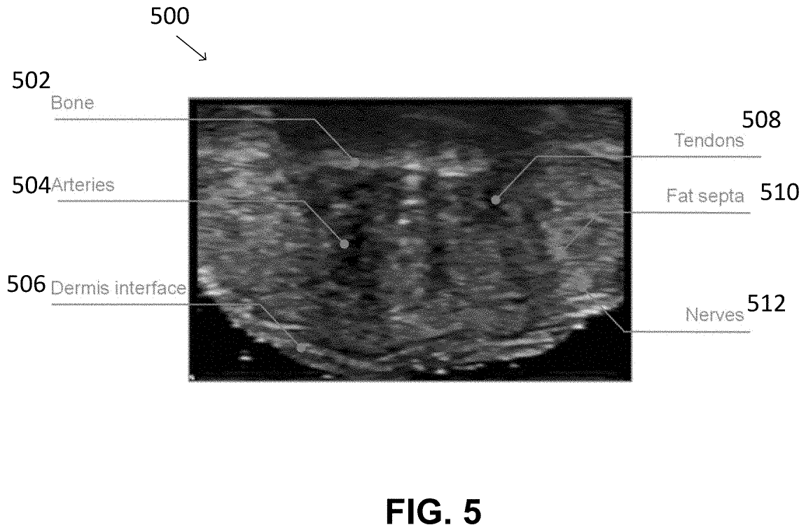

FIG. 5 illustrates an example depth image 500 of a finger, according to an embodiment. Depth image 500 includes a plurality of features inside the finger. Various example features within the finger are illustrated, including bone 502, arteries 504, dermis interface 506, tendons 508, fat septa 510, and nerves 512. Depth image 500 can be acquired during user enrollment for registering a depth image with a user and then again later during an authentication operation for accessing a device and/or application.

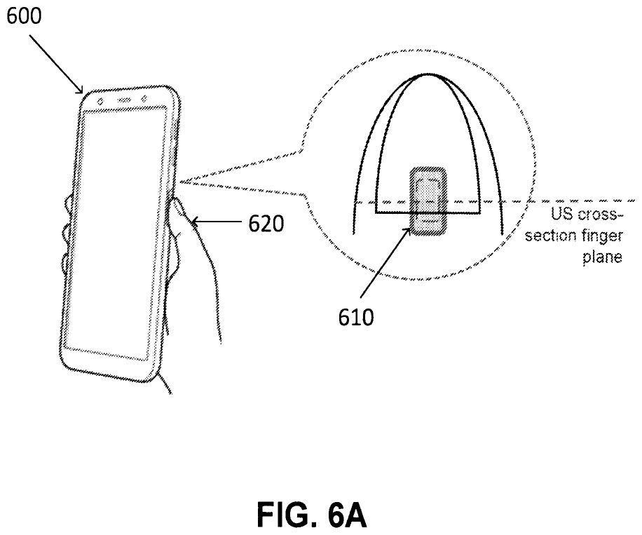

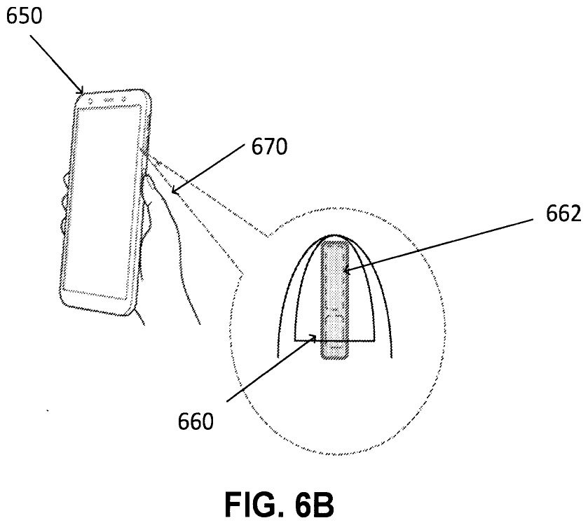

FIG. 6A illustrates an example mobile electronic device 600 having a side-mounted deep finger ultrasonic sensor device 610, according to an embodiment. As illustrated, deep finger ultrasonic sensor device 610 is mounted on mobile electronic device 600 so as to interact with finger 620 such that the depth image captures cross-section of the interior features of the finger traverse with respect to the distal phalanx of finger 620.

FIG. 6B illustrates an example mobile electronic device 650 having a side-mounted deep finger ultrasonic sensor device 660 and fingerprint sensor 662, according to an embodiment. As illustrated, deep finger ultrasonic sensor device 660 is mounted on mobile electronic device 650 so as to interact with finger 670 such that the depth image captures cross-section of the interior features of the finger traverse with respect to the distal phalanx of finger 670.

In accordance with various embodiments, a finger authentication system is described, in which the finger authentication system includes a deep finger ultrasonic sensor device for capturing a depth image of a finger and fingerprint sensor for capturing a fingerprint of the finger. In such embodiments, the deep finger ultrasonic sensor device and the fingerprint sensor can operate cooperatively to perform user authentication, providing increased security for device and/or application access. In some embodiments, embodiments of the described fingerprint authentication system are configured to perform the user authentication in one touch of the finger on the contact layer of the fingerprint authentication system, also referred to herein as a “single touch action.” The single touch action described herein is a single contact between the finger and the fingerprint authentication system (e.g., the time between a user placing a finger on the fingerprint authentication system and removing of the finger from contact with the fingerprint authentication system. In order to perform both fingerprint and depth image capture using the separate sensors in a single touch action, embodiments described herein provide for the spatial distribution of the deep finger ultrasonic sensor device and the fingerprint sensor to preclude against, or at least make highly difficult, deception or circumvention of the fingerprint authentication system.

In accordance with the described embodiments, the fingerprint imaging sensor creates a representation of the ridge/valley pattern of a user's fingerprint via a variety of different imaging modalities such as capacitive, optical or acoustic imaging. The ridge/valley pattern often represents a visual image of the fingerprint and its valley-ridge pattern. For the deep finger ultrasonic sensor, a depth image of features within the finger is acquired.

The fingerprint imaging sensors described herein may be any type of fingerprint sensor used to capture a fingerprint image, e.g., a capacitive fingerprint sensor, an optical fingerprint sensor, or an ultrasonic fingerprint sensor. For ultrasonic sensors, the design may be using a film based piezoelectric material (PVDF-like) or may be using an array of ultrasonic transducers. The ultrasonic transducers may be MEMS-type transducers, for example, using piezoelectric membranes to generate ultrasonic waves. These membranes may have internal support structures in addition to the edge support structures. The piezoelectric materials used may be any material known to the person skilled in the art, such as PZT, Aluminum Nitrate, with or without Sc doping, etc. A minimum dimension is required in order to provide a sufficiently larger area of the fingerprint to compare the captured fingerprint image with the previous stored fingerprint image (template) during enrollment. The exact requirement of the surface and minimum dimension may depend on the fingerprint matching process and the algorithms used. The requirements, for both sensors, may further depend on the required level of security. Moreover, using the deep finger ultrasonic sensor device in combination with the fingerprint sensor may reduce the minimum size of the captured fingerprint image needed for authentication.

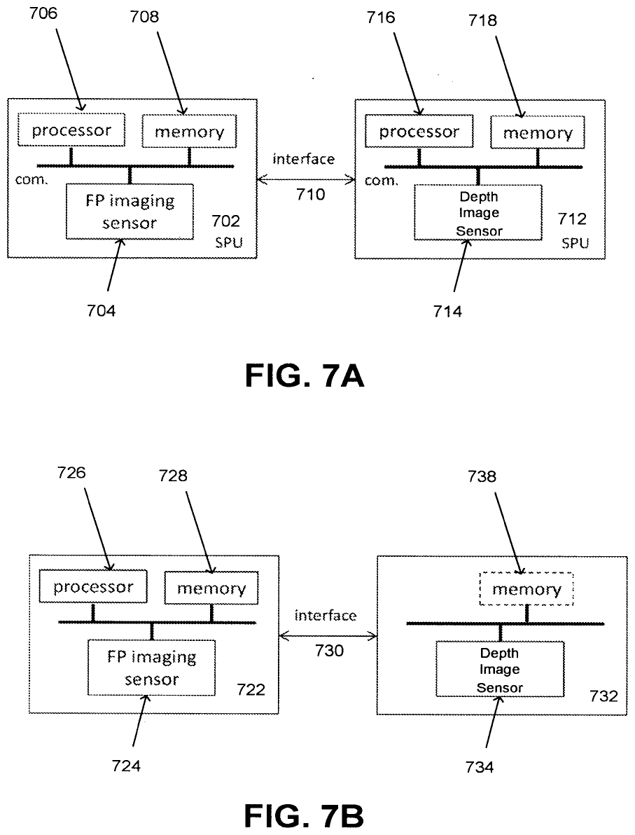

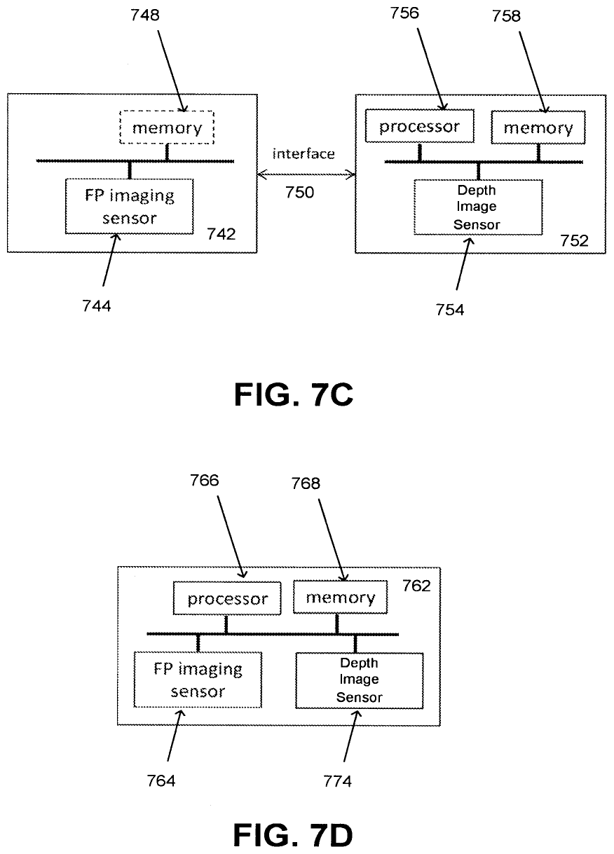

FIGS. 7A through 7D illustrate example hardware configurations of a fingerprint sensing system, according to various embodiments. The fingerprint imaging sensor and the depth image sensor may require a sensor processor for operation and memory for storing algorithms, settings, and data. The different components of the fingerprint imaging sensor and the depth image sensor may communicate through communication lines and may be integrated together in a sensor processing unit (SPU).

FIG. 7A shows an fingerprint imaging sensor 704 of SPU 702 and depth image sensor 714 of SPU 712, where fingerprint imaging sensor 704 has a dedicated sensor processor 706 and sensor memory 708 and depth image sensor 714 has a dedicated sensor processor 716 and sensor memory 718. An interface 710 may exist between fingerprint imaging sensor 704 and the depth image sensor 714 for direct communication. The interface 710 may contain dedicated communication lines (e.g., to reduce latency, improved security and improve operation). For example, the depth image sensor 714 may output a signal indicating the authentication indication, and this output may have a dedicated output pin. In some embodiments, the output/input is cryptographically protected or tokenized to prevent fraud. The fingerprint imaging sensor 704 may have a dedicated input for receiving the authentication indication. Alternatively, the sensors may communicate through an external bus or processor, for example a host processor (not shown).

FIG. 7B shows an embodiment where the depth image sensor 734 does not have its own sensor processor, and where the control of the depth image sensor 734 is performed by an external processor, e.g., the sensor processor 726 of SPU 722 or a host processor. As illustrated, fingerprint imaging sensor 724 of SPU 722 has a dedicated sensor processor 726 and sensor memory 728 and depth image sensor 734 of SPU 732 has a dedicated sensor memory 738. An interface 730 may exist between fingerprint imaging sensor 724 and the depth image sensor 734 for direct communication, and operates in a similar manner as interface 710. For example, the depth image sensor 734 may output a signal indicating the authentication indication, and this output may have a dedicated output pin. In some embodiments, the output/input is cryptographically protected or tokenized to prevent fraud. The fingerprint imaging sensor 724 may have a dedicated input for receiving the authentication indication. Alternatively, the sensors may communicate through an external bus or processor, for example a host processor (not shown).

FIG. 7C shows an embodiment where the fingerprint imaging sensor 744 does not have its own sensor processor, and where the control of the fingerprint imaging sensor 744 is performed by an external processor, e.g., the sensor processor 756 of SPU 752 or a host processor. As illustrated, fingerprint imaging sensor 744 of SPU 742 has a dedicated sensor memory 748 and depth image sensor 754 of SPU 752 has a dedicated sensor processor 756 and sensor memory 758. An interface 750 may exist between fingerprint imaging sensor 744 and the depth image sensor 754 for direct communication, and operates in a similar manner as interface 710. For example, the depth image sensor 754 may output a signal indicating the authentication indication, and this output may have a dedicated output pin. In some embodiments, the output/input is cryptographically protected or tokenized to prevent fraud. The fingerprint imaging sensor 744 may have a dedicated input for receiving the authentication indication. Alternatively, the sensors may communicate through an external bus or processor, for example a host processor (not shown).

FIG. 7D shows an embodiment where fingerprint imaging sensor 764 and depth image sensor 774 are combined in a single SPU 762 with a single sensor processor 766 and sensor memory 768. Any or all functions of the sensor processor 766 may also be performed by an external processor.

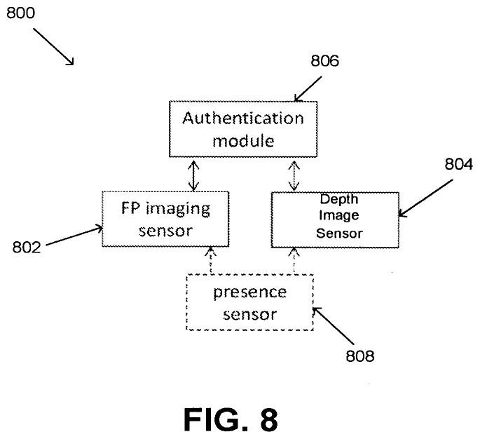

FIG. 8 illustrates an example configuration of the operation of the fingerprint imaging sensor and a depth image sensor in conjunction with an authentication module, according to various embodiments. Operation of the fingerprint sensing system with the fingerprint imaging sensor and the depth image sensor may be done in many different ways. FIG. 8 shows an example embodiment of how the different sensors and modules may work together. For authentication of the user, the image data from the fingerprint imaging sensor and the liveness data from the depth image sensor are both used. The authentication therefore comprises comparing the fingerprint image captured by the fingerprint imaging sensor with the stored fingerprint templates of authorized users and comparing the depth image captured by the depth image sensor with the stored depth image templates of authorized users. The authentication may be done by an authentication module. This authentication module may compare the captured fingerprint image from the fingerprint imaging sensor to the fingerprint images acquired during enrollment (fingerprint templates) and the captured depth image captured by the depth image sensor with the depth image templates images acquired during enrollment (depth image templates). The authentication module may also be referred to as a matcher.

As presented above, embodiments described herein provide for authentication of a user using a fingerprint imaging sensor and a depth image sensor during a single touch action. A one-touch verification module may be used to check a single finger is touching both sensors. For example, the one touch verification module may monitor the initial contact with the sensor (or the finger lifting), and use the initial stage of the finger press to verify the one-touch. When a finger is starting to be pressed onto the sensors, the signal due to the interaction of the sensors with the finger will increase. When a single finger presses on both sensors at the same time, the signal increase for the image sensor and liveness sensor should show similar characteristics and timing. Through comparison of these characteristics and timing the likelihood or confidence of a one-touch occurring can be determined. If this likelihood of confidence is below a threshold, actions may be taken, such as not operating the sensor system, asking the user to press again, or adjusting operation of the sensor(s) and increasing security in the verification process.

In some embodiments, the one-touch verification module uses an optional presence sensor that is used to detect if there is a finger present on the sensor. If the presence sensor has detected a finger, it may indicate the finger presence to the fingerprint imaging sensor and/or depth image sensor. The use of a presence sensor may use lower resources (battery, processing), and may wake the fingerprint imaging sensor and/or depth image sensor from a lower power mode.

FIG. 8 shows an example embodiment of configuration 800 where the fingerprint imaging sensor 802 sends the image data (captured fingerprint image) to the authentication module 806 and the depth image sensor 804 sends the depth image data (captured depth image) to the authentication module 806. Both fingerprint imaging sensor 802 and the depth image sensor 804 interact with the authentication module 806 individually. The authentication module 806 then processes both the image data and the depth image data to authenticate the user. In some embodiments, authentication module 806 also processes the image data and depth image data to make sure the captured fingerprint image is not from a fake or spoof finger. The authentication module 806 may also function on one of the fingerprint imaging sensor 802 or depth image sensor 804 or may run on an external/host processor. The fingerprint imaging sensor 802 and depth image sensor 804 may be operated simultaneously, to minimize latency when a user places a finger on the sensor system. Alternatively, fingerprint imaging sensor 802 and depth image sensor 804 may be operated sequentially, where the detection of a finger on one sensor triggers the operation of the other sensor. In some embodiments, configuration 800 includes optional presence sensor 808 that is used to detect if there is a finger present on the presence sensor 808. If the presence sensor 808 has detected a finger, it may indicate the finger presence to the fingerprint imaging sensor 802 and/or depth image sensor 804.

### Example Operations for Performing Fingerprint Authentication Using a Deep Finger Ultrasonic Sensor

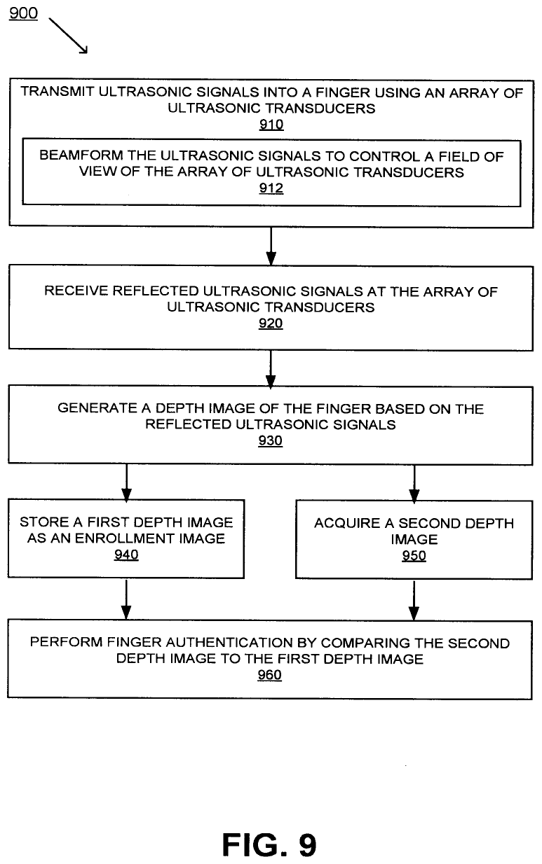

FIG. 9 illustrates an example flow diagram 900 of a method of user authentication using a deep finger ultrasonic sensor, according to embodiments. Procedures of these methods will be described with reference to elements and/or components of various figures described herein. It is appreciated that in some embodiments, the procedures may be performed in a different order than described, that some of the described procedures may not be performed, and/or that one or more additional procedures to those described may be performed. The flow diagrams include some procedures that, in various embodiments, are carried out by one or more processors (e.g., a host processor or a sensor processor) under the control of computer-readable and computer-executable instructions that are stored on non-transitory computer-readable storage media. It is further appreciated that one or more procedures described in the flow diagrams may be implemented in hardware, or a combination of hardware with firmware and/or software.

At procedure 910, ultrasonic signals are transmitted into a finger using the array of ultrasonic transducers. In some embodiments, the array of ultrasonic transducers is a one-dimensional array or two-dimensional array of ultrasonic transducers. In some embodiments, as shown at procedure 912, transmitting the ultrasonic signals into the finger using the array of ultrasonic transducers includes beamforming the ultrasonic signals, where the beamforming controls a field of view of the array of ultrasonic transducers. At procedure 920, reflected ultrasonic signals are received at the array of ultrasonic transducers.

At procedure 930, a depth image of the finger is generated based at least in part on the reflected ultrasonic signals, where the depth image comprises a cross-section image of the finger comprising a plurality of features inside the finger. In accordance with various embodiments, the features inside the finger can include, without limitation: a dermis epidermis interface, a capillary, a blood vessel, a tendon, an artery, a nerve, a bone, a fascial septa, and a Meissner's corpuscle. In some embodiments, the depth image includes a cross-section image of the finger including the plurality of features inside the finger.

In some embodiments, as shown at procedure 940, a first depth image of the finger is stored as an enrollment depth image. In some embodiments, as shown at procedure 950, a second depth image of the finger is captured during finger authentication. In both the first and second images, features are extracted and distances of the features are stored. In some embodiments, as shown at procedure 960, finger authentication is performed by comparing a features and relative distances of the second depth image to the features and relative distances of the first depth image.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. Many aspects of the different example embodiments that are described above can be combined into new embodiments. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A deep finger ultrasonic sensor device comprising:
an array of ultrasonic transducers; and
an array controller configured to control activation of ultrasonic transducers of the array of ultrasonic transducers during an imaging operation for capturing a depth image of a finger, wherein the depth image comprises a plurality of features inside the finger, the array controller configured to:
control transmission of ultrasonic signals and receipt of reflected ultrasonic signals during the imaging operation, wherein the reflected ultrasonic signals are utilized in generating the depth image of the finger.

2. The deep finger ultrasonic sensor device of claim 1, wherein the array controller is further configured to:
control beamforming during the imaging operation, wherein the beamforming controls a field of view of the array of ultrasonic transducers.

3. The deep finger ultrasonic sensor device of claim 1, wherein the features inside the finger comprise at least one of: a dermis epidermis interface, a capillary, a blood vessel, a tendon, an artery, a nerve, a bone, a fascial septa, and a Meissner's corpuscle.

4. The deep finger ultrasonic sensor device of claim 1 further comprising a sensor processor, the sensor processor configured to:
generate the depth image of the finger based at least in part on the reflected ultrasonic signals.

5. The deep finger ultrasonic sensor device of claim 4, the sensor processor further configured to:
store a first depth image of the finger as an enrollment depth image.

6. The deep finger ultrasonic sensor device of claim 5, the sensor processor further configured to:
perform finger authentication by comparing a second depth image to the first depth image.

7. The deep finger ultrasonic sensor device of claim 1, wherein the deep finger ultrasonic sensor device is mounted on a side of a mobile electronic device.

8. The deep finger ultrasonic sensor device of claim 1, wherein the array of ultrasonic transducers is a one-dimensional array of ultrasonic transducers.

9. The deep finger ultrasonic sensor device of claim 1, wherein the depth image comprises a cross-section image of the finger comprising the plurality of features inside the finger.

10. A method for deep finger sensing using an array of ultrasonic transducers, the method comprising:
transmitting ultrasonic signals into a finger using the array of ultrasonic transducers;
receiving reflected ultrasonic signals at the array of ultrasonic transducers; and
generating a depth image of the finger based at least in part on the reflected ultrasonic signals, wherein the depth image comprises a cross-section image of the finger comprising a plurality of features inside the finger.

11. The method of claim 10, wherein the transmitting ultrasonic signals into the finger using the array of ultrasonic transducers comprises:
beamforming the ultrasonic signals, wherein the beamforming controls a field of view of the array of ultrasonic transducers.

12. The method of claim 10, wherein the features inside the finger comprise at least one of: a dermis epidermis interface, a capillary, a blood vessel, a tendon, an artery, a nerve, a bone, a fascial septa, and a Meissner's corpuscle.

13. The method of claim 10, further comprising:
storing a first depth image of the finger as an enrollment depth image.

14. The method of claim 13, further comprising:
performing finger authentication by comparing a second depth image to the first depth image.

15. The method of claim 10, wherein the array of ultrasonic transducers is a one-dimensional array of ultrasonic transducers.

16. A user authentication system comprising:
a fingerprint imaging sensor comprising a two-dimensional array of ultrasonic transducers, the fingerprint imaging sensor for capturing a fingerprint image of a finger;
a deep finger sensor for capturing a depth image of the finger, wherein the depth image comprises a cross-section image of the finger comprising a plurality of features inside the finger; and
a processor, wherein the processor is configured to perform a user authentication operation using the fingerprint image and the depth image.

17. The user authentication system of claim 16, wherein the processor is further configured to:
control beamforming of the deep finger sensor for capturing the depth image, wherein the beamforming controls a field of view of the one-dimensional array of ultrasonic transducers.

18. The user authentication system of claim 16, wherein the features inside the finger comprise at least one of: a dermis epidermis interface, a capillary, a blood vessel, a tendon, an artery, a nerve, a bone, a fascial septa, and a Meissner's corpuscle.

19. The user authentication system of claim 16, the processor further configured to:
store a first fingerprint image as an enrollment fingerprint image; and
store a first depth image of the finger as an enrollment depth image.

20. The user authentication system of claim 19, the processor further configured to:
perform finger authentication by comparing a second fingerprint image to the first fingerprint image and a second depth image to the first depth image.

21. The user authentication system of claim 16, wherein the deep finger sensor comprises a one-dimensional array or a two dimensional array of ultrasonic transducers.
